(19) United States
(12) Patent Application Publication
(10) Pub. No.: US 2018/0137495 A1
(43) Pub. Date: May 17, 2018

(54) LAYAWAY SYSTEM

(71) Applicant: Wal-Mart Stores, Inc., Bentonville, AR (US)

(72) Inventors: Subodh Kumar Pandey, Bentonville, AR (US); Jimmie R. Clark, Fayetteville, AR (US); Christopher Soames Johnson, Pea Ridge, AR (US); Todd Mattingly, Bentonville, AR (US)

(21) Appl. No.: 15/807,928

(22) Filed: Nov. 9, 2017

Related U.S. Application Data
(60) Provisional application No. 62/420,919, filed on Nov. 11, 2016.

(51) Int. Cl. G06Q 20/22; G06Q 10/08; G06Q 10/10; G05D 1/02

(52) U.S. Cl. CPC G06Q 20/29; G06Q 10/0836; G05D 2201/0216; G05D 1/0225; G05D 1/0276; G06Q 10/109

(57) ABSTRACT

Described is a layaway system for a retail store that includes a layaway processing utility, a detector, and a drone. The layaway processing utility electronically stores information about the layaway account and communicates with customers. The detector detects when a customer has entered the retail store and communicates with the layaway processing utility. The drone is loaded with layaway merchandise of the customer and automatically finds and delivers the layaway merchandise to the customer in the retail store. The customer can interact with the layaway processing utility using a mobile computing device to schedule the layaway pickup, and/or to make a payment on their layaway account. The layaway system reduces the wait time for customers wish to pick up their layaway items, provides easy ways for the customer to schedule their layaway pickup, and minimizes the employee time needed to find and deliver the layaway merchandise.

### CROSS REFERENCE TO RELATED APPLICATION

This invention claims priority to U.S. provisional patent application Ser. No. 62/420,919, filed Nov. 11, 2016 to Applicant Wal-Mart Stores Inc., and entitled “Layaway System”, which is incorporated entirely herein by reference.

### BACKGROUND OF THE INVENTION

### Technical Field

This invention relates to layaway systems at retail stores, and specifically to a system and method for delivering items from layaway to a customer using a drone or autonomous vehicle.

### State of the Art

Retail stores use layaway accounts as a method for customers to purchase items by making payments over a period of time. A customer opens a layaway account for one or more items, and makes payments on the items until the balance owed on the layaway account is paid off. The retail store holds the items for the customer in storage until the layaway account balance is paid off. Once the layaway account balance is paid off by the customer, the layaway account merchandise can be picked up by the customer. When customers come into a retail store and pay off their layaway account balance, they wish to be able to pick up their layaway items quickly. Often, however, customers are made to wait while a store employee finds and delivers the layaway merchandise. During busy times of the retail store, the customer may have to wait an unacceptable amount of time for their layaway merchandise to be found and delivered by an employee.

Accordingly, what is needed is a layaway system that reduces wait time for customers picking up layaway merchandise in a retail store.

### BRIEF DESCRIPTION OF THE DRAWINGS

FIG. 1 shows a simplified illustration of a layaway system of a retail store;

FIG. 2 shows a simplified block diagram of the layaway system of FIG. 1;

FIG. 3 shows an illustration of a customer receiving their layaway item via a drone of the layaway system;

FIG. 4 is an illustration of a customer obtaining information regarding their layaway account from a retail store kiosk; and

FIG. 5 illustrates a method of storing and delivering layaway merchandise to a customer.

### DETAILED DESCRIPTION OF EMBODIMENTS OF THE INVENTION

As discussed above, disclosed are embodiments of an invention that relates to layaway systems at retail stores, and specifically to a system and method for delivering items from layaway to a customer using a drone or autonomous vehicle. Layaway accounts are in common usage at retail stores as a way for customers to pay for layaway merchandise over a period of time. A customer opens a layaway account with the retail store. The retail store keeps the layaway items in storage for the customer. The customer makes payments on the layaway account, and when it is paid off, the customer collects the layaway items from the store. One of the steps in this process that can get backed up is when the customer comes to pick up their merchandise at the retail store. The customer often has to wait while a store employee finds and delivers the layaway items. The disclosed layaway system provides improved service to a customer in a number of ways. The disclosed layaway system and method of storing and delivering layaway items provides a means for the customer to preschedule pickups. The disclosed layaway system and method of storing and delivering layaway items also provides a way for the layaway system of the retail store to detect when a customer enters the store and let them know the balance on their account, so the customer can decide if they want to pay off their layaway account and pick up the merchandise while they are in the store. Also, the disclosed layaway system and method of storing and delivering layaway merchandise uses an automated drone cart or autonomous vehicle to deliver and/or store layaway merchandise. Using a drone or autonomous vehicle to deliver items to the customer in the retail store minimizes the use of employees and speeds up delivery of the layaway merchandise. Using a drone or autonomous vehicle to store items minimizes employee time transferring items from one place to another.

Disclosed is a system and method of delivering layaway merchandise that includes a layaway processing utility, a detector, and a drone. A drone is any autonomous, or robotic, vehicle of any size. The layaway processing utility electronically stores information about the layaway account and communicates with the customer. The detector detects when the customer has entered the retail store and communicates with the layaway processing utility. The drone is loaded with the layaway merchandise (one or more layaway items) of the customer and automatically finds and delivers the layaway merchandise to the customer in the retail store. The customer can interact with the layaway processing utility using a mobile computing device to schedule the layaway pickup, and/or to make a payment on their layaway account. In some embodiments, the customer opens the layaway account online. When the customer enters the retail store, the layaway processing utility will be informed that the customer is in the store by the detector. The layaway processing utility will communicate with the customer to determine if they wish to pick up and/or pay off their layaway account. Once the layaway account is paid off and ready for delivery, the layaway processing utility provides for delivery of the one or more layaway items. In some embodiments, the layaway processing utility instructs a retail store employee to load the layaway merchandise into a drone, and instructs the drone to find the customer in the store and deliver the layaway merchandise to them. In some embodiments, the layaway merchandise is loaded into the drone when the layaway account is opened, and the layaway processing utility instructs the drone to deliver the items once the layaway account is paid off. In some embodiments, the drone is stored in its own garage controlled by the drone. When the drone gets the instruction to deliver items, the drone opens a door of the drone garage and delivers the merchandise. The disclosed layaway system reduces the wait time for customers to pick up their layaway items, provides easy ways for the customer to schedule their layaway pickup, and minimizes the employee time needed to find and deliver the layaway merchandise.

Disclosed is a system for organizing layaway pickups that includes a means for detecting that a customer has entered a retail store, and a means for robotically delivering layaway merchandise to the customer in response to detecting that the customer has entered the retail store. In some embodiments, the system for organizing layaway pickups includes a means for determining if the customer has a layaway account at the retail store. In some embodiments, the system for organizing layaway pickups includes a means for communicating a layaway account payoff balance to the customer. Disclosed is a system for organizing layaway pickups that includes a means for detecting that a customer has paid off their layaway balance, and a means for robotically delivering layaway merchandise to the customer in response to detecting that the layaway balance has been paid off.

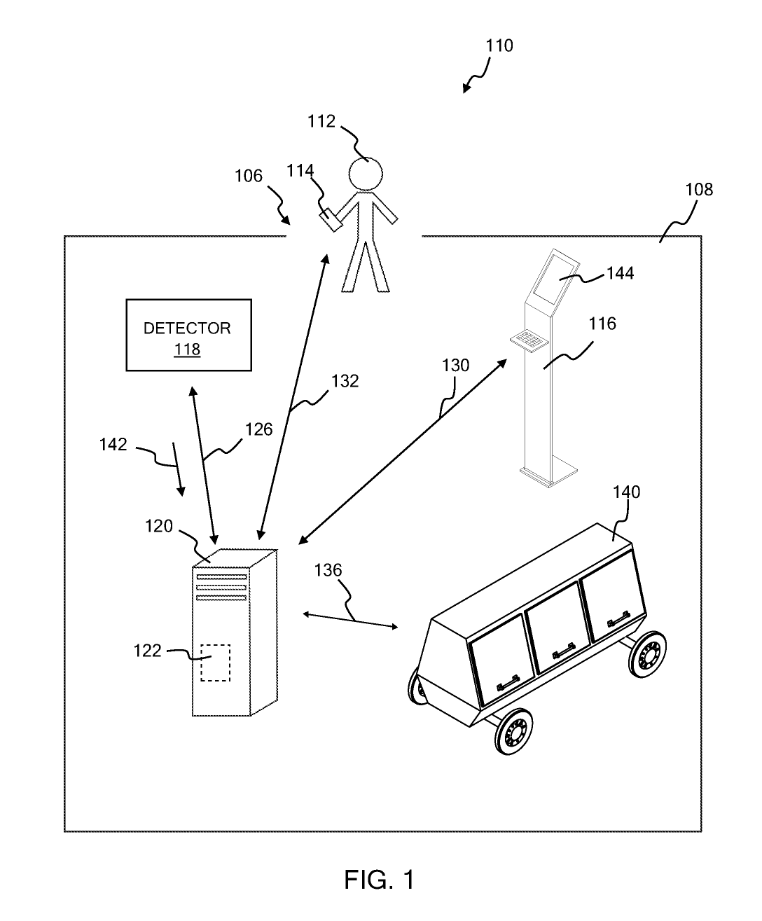

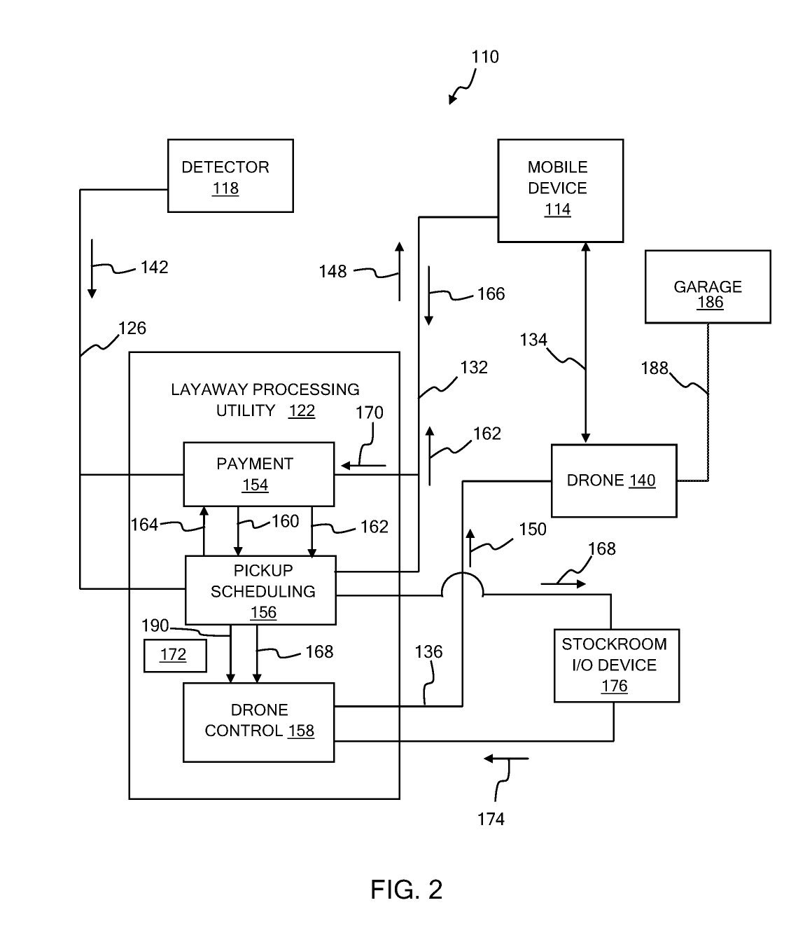

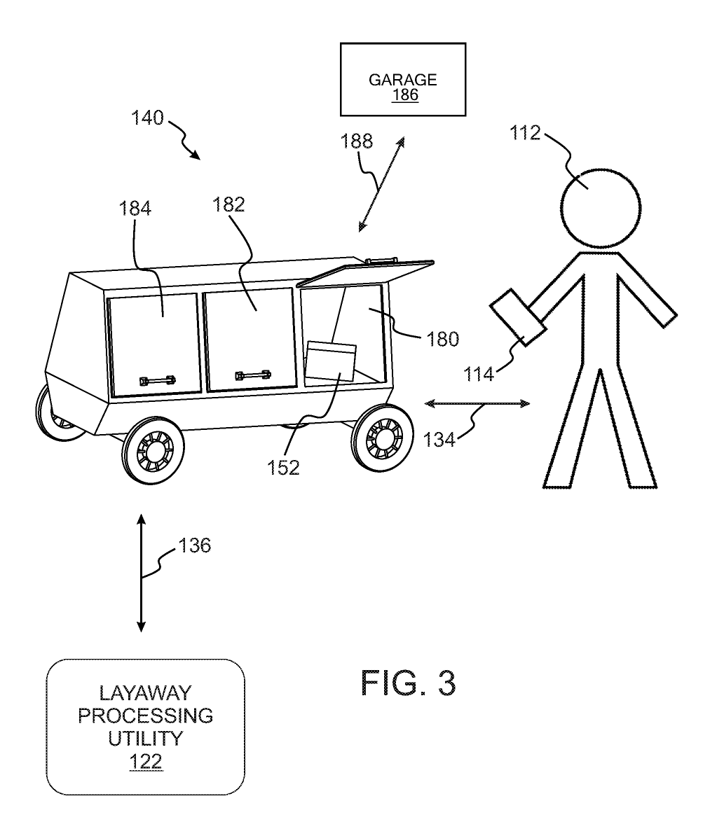

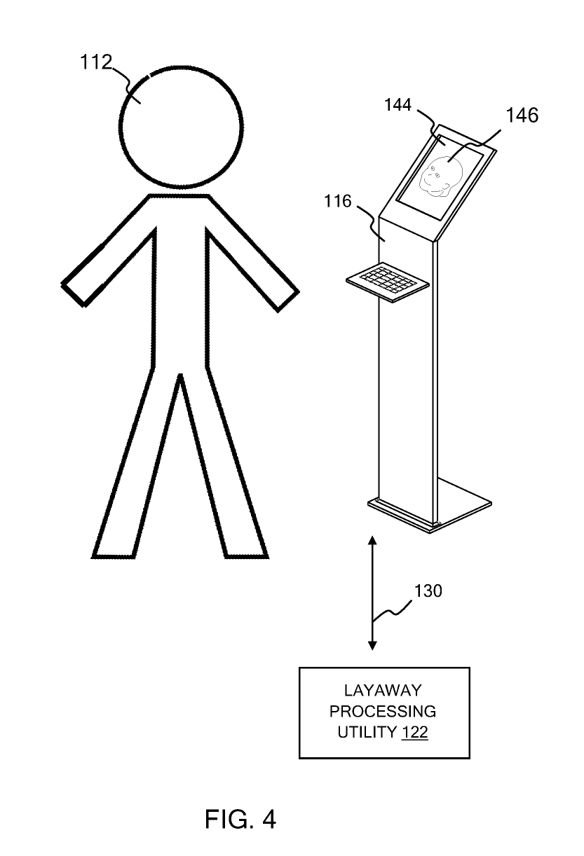

FIG. 1 through FIG. 4 show a layaway system 110 for a retail store 108. Layaway system 110 is a system for organizing layaway pickups. FIG. 1 shows a simplified illustration of layaway system 110. FIG. 2 shows a simplified block diagram of layaway system 110. FIG. 3 shows a customer 112 receiving a layaway item 152 from a drone 140 of layaway system 110. FIG. 4 shows customer 112 interacting with a kiosk 116 of layaway system 110. Layaway system 110 includes a layaway processing utility 122, a detector 118 communicatively coupled to layaway processing utility 122, and a drone 140 communicatively coupled to layaway processing utility 122, as shown in FIG. 1 and FIG. 2. In some embodiments layaway system 110 includes a drone garage 186 (FIG. 2 and FIG. 3) for storing drone 140 and layaway items in drone 140.

Layaway system 110 provides a means to set up layaway accounts, store layaway items, interact with the customer about their layaway account, accept layaway payments, and deliver layaway items once the layaway account is paid off. Layaway system 110 streamlines the layaway system and minimizes the number of employees and amount of employee time needed to store and deliver layaway items. Layaway system 110 makes it easy for customers to set up and maintain their layaway accounts, and minimizes the customer time and effort needed to obtain delivery of their layaway items.

Layaway processing utility 122 is a layaway program and database designed to store information and data related to layaway accounts of retail store 108. Layaway processing utility 122 stores data on each layaway account, accepts and tracks payments to layaway accounts, and is the information database for the layaway accounts of retail store 108. Retail store 108 can be one store or a chain of retail stores. Layaway processing utility 122 can cover the layaway accounts for one store or a chain of stores, for example. In the embodiment shown in FIG. 1, layaway processing utility 122 is resident on a server 120. Server 120 is resident in retail store 108 in this embodiment, but this is not meant to be limiting. Layaway processing utility 122 can be resident on any computing device or memory, in hardware, firmware or software, on a cloud server or a server that covers multiple facilities, or any other device that holds layaway processing utility 122 and supports communications to and from layaway processing utility 122. Layaway processing utility 122 stores a layaway account, such as layaway account 172 of a customer 122 in this embodiment, which is associated with a layaway item 152.

Retail store 108, in the embodiment of layaway system 110 shown in FIG. 1 through FIG. 4, is a brick and mortar store that includes server 120, detector 118, kiosk 116, and drone 140, as shown in FIG. 1. In some embodiments, server 120 is remote from retail store 108. In the embodiment shown in the figures, drone 140 is stored in a drone garage 186 (FIG. 2 and FIG. 3), which is contained in retail store 108, in this embodiment.

Detector 118 is communicatively coupled to layaway processing utility 122 via communication 126 (FIG. 1 and FIG. 2). Communication 126 can be wired or wireless and can be accomplished via any communication type, standard, or protocol used now or in the future. Detector 118 detects when customer 112 enters retail store 108, as shown in FIG. 1. In this embodiment, detector 118 is positioned near entry 106 of retail store 108 to detect the entry of customer 112 into retail store 108. Detector 118 sends layaway processing utility 122 a customer detection indicator 142 in response to detecting that customer 112 has entered retail store 108. Detector 118 can use many different methods to detect customer 112 entering into retail store 108. Detector 118 and/or layaway processing utility 122 can use many different methods to determine the identity of customer 112. Detector 118 can use radio-frequency identification (RFID) devices, image recognition, near-field communication (NFC) protocol or devices, optical or radio-wave detection, or any other method of detecting that customer 112 has entered retail store 108 and/or determining the identity of customer 112. In the embodiment shown, detector 118 detects a mobile computing device 114 of customer 112 and determines that customer 112 has entered retail store 108 by retrieving from a store database the identity of the owner of mobile computing device 114. In some embodiments, however, customer 112 does not have mobile computing device 114 and detector 118 uses other means to detect customer 112 entering retail store 108 and/or to determine the identity of customer 112. In some embodiments, detector 118 detects customer 112 entering retail store 108, obtains data on customer 112, and sends this data to layaway processing utility 122 for layaway processing utility 122 to determine the identity of customer 112. Detector 118 is, in this embodiment, a means for detecting that customer 112 has entered retail store 108. Detector 118 and/or layaway processing utility 122 are a means for determining the identity of customer 112.

Drone 140 is any type of autonomous, unmanned or robotically-controlled vehicle that moves inside of or outside of retail store 108, and can be loaded with layaway merchandise to deliver layaway merchandise to customer 112. It is to be understood that drone 140 is a cart-type drone in this example, but this is not meant to be limiting. Drone 140 is shown as a wheeled vehicle in the figures, but this is not meant to be limiting. In some embodiments, drone 140 is a winged vehicle such as a flying drone or airplane. Drone 140 can also be a mobile box, a car or a truck, or any other type of robotic, remotely controlled, or autonomous vehicle. Drone 140 can be any size or configuration of autonomous vehicle. Drone 140 is communicatively coupled to layaway processing utility 122 via communication 136 as shown in FIG. 1, FIG. 2, and FIG. 3. Once detector 118 detects that customer 112 has entered retail store 108, layaway processing utility 122 determines whether customer 112 has a layaway account with retail store 108. If customer 112 does have a layaway account with retail store 108, layaway processing utility 122 determines whether the layaway account has been paid off, and whether a layaway pickup has been scheduled. If there is a layaway account balance, layaway processing utility 122 communicates with customer 112 as described below to determine if customer 112 wishes to pay off the layaway balance and pick up the layaway merchandise while they are in the store. If layaway processing utility 122 determines that layaway merchandise is to be delivered to customer 112 while they are in retail store 108, layaway processing utility 122 provides instructions for delivery of the layaway item or items. In some embodiments, layaway item 152 of layaway account 172 of customer 112 is stored in drone 140 when layaway account 172 is opened. Once any balance due on layaway account 172 is paid off, layaway processing utility 122 sends a delivery request 150 to drone 140 to deliver layaway item 152 (FIG. 3) to customer 112. Drone 140, stored in drone garage 186 in this embodiment (FIG. 2 and FIG. 3), autonomously opens drone garage 186, and delivers layaway item 152 to customer 112, either in store 108, or, in some embodiments, at the home of customer 108 or other location. Drone 140 delivers layaway item 152 to customer 112 in response to receiving delivery request 150 (FIG. 2) from layaway processing utility 122.

Drone garage 186 can be any type of storage facility for drone 140. In this embodiment, drone garage 186 has a garage door that opens to allow drone 140 to enter and exit. Drone garage 186 is autonomously controlled by drone 140 (as well as other systems) so that drone 140 can open and close the drone garage door and exit and enter without human help. Drone garage 186, in this embodiment, is a type of merchandise storage facility for both drone 140 and layaway item 152. Drone 140 is communicatively coupled to drone garage 186 using a communication link 188 (FIG. 2 and FIG. 3). Layaway item 152 has to be stored somewhere, so to minimize human involvement, it is stored in drone 140 so that drone 140 can both keep layaway item 152 stored and safe until layaway account 172 is paid off, and deliver layaway item 152 to customer 112 without employee help. Layaway item 152 is loaded into drone 140 when customer 112 opens layaway account 172. Layaway item 152 and drone 140 are stored in drone garage 186 until layaway account 172 is paid off. Drone 140 communicates with drone garage 186 using communication link 188. Drone 140 instructs drone garage 186 to open and close the garage door, for example, using communication link 188. Drone 140 can use communication link 188 for many other types of communication with drone 140.

In some embodiments, layaway item 152 is not stored in drone 140. In this example embodiment where layaway item 152 is stored separate from drone 140, layaway processing utility 122 provides instructions to one or more employee of retail store 108 to load drone 140 with layaway item 152 (FIG. 3) belonging to customer 112, and then instructs drone 140 to deliver layaway item 152 to customer 112. Once drone 140 is loaded with layaway item 152, drone 140 delivers layaway item 152 to customer 112 in response to receiving a delivery request 150 (FIG. 2) from layaway processing utility 122.

In another example embodiment, layaway item 152 is stored in an automated bin, which automatically loads layaway item 152 into drone 140 stored in drone garage 186 once layaway account 172 is paid off. This can be done with no human interaction.

In the embodiment of system 110 shown in the figures, drone 140 is a means for robotically and/or autonomously delivering layaway item 152 to customer 112 in response to detector 118 detecting that customer 112 has entered retail store 108. Layaway processing utility 122 is a means for determining if customer 112 has a layaway account at retail store 108. If layaway processing utility 122 has a layaway account stored in its database for customer 112, then layaway processing utility 122 determines that customer 112 has a layaway account at retail store 108. In the embodiment shown in the figures, layaway processing utility 122 determines that customer 112 has layaway account 172 (FIG. 2) with retail store 108.

If layaway processing utility 122 determines that customer 112 does not have a layaway account with retail store 108, then no further action is taken by layaway processing utility 122 with respect to customer 112.

Referring back to FIG. 1 through FIG. 4, layaway processing utility 122 determines that customer 112 has layaway account 172 with retail store 108 in response to detector 118 detecting that customer 112 has entered retail store 108. Layaway processing utility 122 determines that customer 112 has layaway account 172, and that layaway item 152 is associated with layaway account 172. Layaway processing utility 122 determines if there is a balance due on layaway account 172, and/or if customer 112 has pre-scheduled a pickup of layaway item 152. If customer 112 has pre-scheduled a pickup of layaway item 152, and if layaway account 172 is paid off, drone 140, pre-loaded with layaway item 152, will be used to deliver layaway item 152 to customer 112. In this embodiment shown in the figures, layaway processing utility 122 will send drone 140 a delivery request 150 (FIG. 2) in response to detector 118 detecting that customer 112 has entered retail store 108. Delivery request 150 is an instruction to drone 140 to deliver layaway item 152 to customer 112. In some embodiments, customer 112 will request home delivery. If this is an option for drone 140, layaway processing utility 122 will instruct drone 140 to deliver layaway item 152, and drone 140 will deliver layaway item 152 to the home of customer 112.

In some embodiments where drone 140 is not available to deliver to a home, shipping services will be used to deliver layaway item 152 to the home of customer 112. In some embodiments, shipping of item 152 is coordinated with delivery trucks that maybe going to or near the home anyways. This coordination of shipping reduces shipping costs for the customer and the retail store.

Referring again to the embodiment pf layaway system 110 shown in FIG. 1 through FIG. 4, customer 112 can pre-schedule the layaway pickup using mobile computing device 114 communicating with layaway processing utility 122, for example, or by using another computing device to communicate with layaway processing utility 122, or by any other method such as calling retail store 108 to schedule the pickup.

In the embodiment shown in the figures, drone 140 will find customer 112 in retail store 108 and deliver layaway item152 to customer 112, as shown in FIG. 3. Drone 140 can communicate with mobile computing device 114 to find customer 112, or can meet customer 112 at a pre-arranged place in retail store 108. Drone 140, in this embodiment, is communicatively coupled to mobile computing device 114 via communication 134, as shown in FIG. 2 and FIG. 3. Communication 134 is wireless communication in this embodiment, but that is not meant to be limiting. Communication 134 can be wired, wired, electrical, optical, or any other type of communication, using any type, protocol, or method of communication rules. Communication 134 can be used for many different types of communication, including for drone 140 to find customer 112 in retail store 108, and for customer 112 to retrieve item 152 from drone 140, for example. In some embodiments, communication 134 can include layaway payments made from the customer using mobile computing device 114.

Drone 140, in the embodiment shown in the figures, has a number of compartments to hold merchandise for different customers. In the embodiment shown in the figures, drone 140 has three compartments, compartment 180, compartment 182, and compartment 184. Compartment 180 is loaded with layaway item 152 for customer 112. Compartments 180, 182, and 184 are each locked. Compartments 180, 182, and 184 are locked so that only the customer whose layaway merchandise is in a particular compartment can open that particular compartment. Layaway processing utility 122, in this embodiment, provides customer 112 with a code to open compartment 180 via communication 132 (FIG. 1 and FIG. 2). Drone 140 uses mobile computing device 114, in this embodiment, to find customer 112 in retail store 108. Customer 112 uses the code provided by layaway processing utility 122 to mobile computing device 114 via communication 132 to open compartment 180, and customer 112 retrieves layaway item 152.

In some embodiments, drone 140 does not have multiple compartments. In this example embodiment, drone 140 has only one compartment, such as compartment 180, and drone 140 stores and delivers only one customer's layaway merchandise. Once the customer picks up the layaway merchandise, drone 140 is loaded with the merchandise for a new layaway account and is stored in layaway garage 186 until the layaway account is paid off.

Customer 112 can open compartment 180 in many different ways, not limited to a code. In some embodiments, customer 112 will use a radio-frequency identification (RFID) or near field communication (NFC) tag that has been programmed for customer 112. In some embodiments, customer 112 will use a loyalty card provided by retail store 108 to open compartment 180 of drone 140. Layaway processing utility 122 and retail store 108 can provide customer 112 any number of secure means to open compartment 180 to retrieve layaway item 152. The secure means will allow customer 112 to open compartment 180, but not open other compartments 182 and 184 of drone 140, and will not allow other customers to access compartment 180.

If customer 112 did not pre-schedule a pickup of layaway item 152, layaway processing utility 122 will, in response to detector 118 detecting that customer 112 has entered retail store 108, and layaway processing utility 122 determining that customer 112 has layaway account 172, communicate with customer 122 to determine if customer 112 will be picking up layaway item 152 during their visit to retail store 108. If customer 112 has mobile computing device 114, as shown in the figures, then communication 132 between mobile computing device 114 and layaway processing utility 122 can be used to determine if layaway item 152 is to be picked up. In some embodiments, however, customer 112 may not have mobile computing device 114. In some embodiments, a kiosk 116 can be used for communication between customer 112 and layaway processing utility 122, as shown in FIG. 4. In some embodiments, other method are used for communication between customer 112 and layaway processing utility 122, such as communication between customer 112 and an employee of retail store 108, for example, but not by way of limitation. The employee that talks with customer 112 can enter the information into layaway processing utility 122. In some embodiments, customer 112 and layaway processing utility 122 communicate via internet of other computer interface connection.

Kiosk 116 and communication 130 (FIG. 1 and FIG. 4) is used, in some embodiments, for layaway processing utility 122 to determine if customer 112 is going to pick up layaway item 152. If customer 112 does not have a mobile computing device, for example, customer 112 can visit kiosk 116 to communicate with layaway processing utility 122, as shown in FIG. 4. Layaway processing utility 122 can use a rendering of a person 146 on a display 144 of kiosk 116 to interact with customer 112. Kiosk 116 can use any type of input device such as a keyboard or voice recognition, for example but not by way of limitation, to receive input from customer 112. Rendering of a person 146 can tell customer 112 the status of layaway account 172, the balance owed, can take payments, and find out if customer 112 will be pickup up layaway item 152. If customer 112 pays off their layaway account 172 and wishes to pick up layaway item 152, layaway processing utility 122 will send delivery request 150 to drone 140, and drone 140 will deliver layaway item 152 to customer 112. Drone 140 can deliver layaway item 152 to customer 112 at kiosk 116 or at any other predetermined location in retail store 108. In some embodiments, kiosk 116 can be outside of retail store 108 so that customer 112 can pick up layaway item 152 after hours, for example. In some embodiments, kiosk 116 is at a mall or other public place. In some embodiments where drone 140 is not pre-loaded with layaway item 152, layaway processing utility 122 will arrange for layaway item 152 to be loaded into drone 140.

Referring back to the embodiment shown in FIG. 1, FIG. 2, and FIG. 3, when customer 112 has mobile computing device 114, detector 118 detects mobile computing device 114 entering retail store 108 and sends layaway processing utility 122 customer detection indicator 142 in response to detecting that mobile computing device 114 of customer 112 has entered retail store 108. Detector 118 and/or layaway processing utility 122 determines the identity of customer 112 using mobile computing device 114, and determines that customer 112 has layaway account 172 with retail store 108. Customer 112 has not pre-scheduled a layaway pickup, in this example embodiment.

Layaway processing utility 122 sends a layaway pickup query 148 (FIG. 2) to mobile computing device 114 in response to detector 118 detecting that customer 112 has entered retail store 108 and layaway processing utility 122 determining that customer 112 has layaway account 172 with retail store 108. Layaway pickup query 148 requests that customer 112 provide input as to whether they are going to pick up their layaway item 152 while they are in retail store 108.

Layaway processing utility 122, in this embodiment, includes a payment module 154, a pickup scheduling module 156, and a drone control module 158, as shown in FIG. 2. Layaway processing utility 122, payment module 154, pickup scheduling module 156, and drone control module 158 can be implemented in software, hardware circuitry, firmware, or some combination of software, hardware, and firmware. In some embodiments, payment module 154, pickup scheduling module 156, and/or drone control module 158 are special purpose hardware circuitry designed specifically for layaway processing use.

Payment module 154 sends a balance paid indicator 160 to pickup scheduling module 156 in response to customer 112 paying off the balance of layaway account 172, or a layaway account payoff amount 162 being equal to zero. Layaway account payoff amount 162 is the amount owed on the layaway account. The payment of layaway account payoff amount 162 can happen before customer 112 visits retail store 108 or while customer 112 is in retail store 108.

Payment module 154 sends layaway account payoff amount 162 to pickup scheduling module 156. In some embodiments, payment module 154 sends layaway account payoff amount 162 to pickup scheduling module 156 in response to payment module 154 receiving a payoff amount request 164 from pickup scheduling module 156. In some embodiments, payment module 154 sends layaway account payoff amount 162 to pickup scheduling module 156 in response to detector 118 detecting that customer 112 has entered retail store 108 and pickup scheduling module 156 sending layaway pickup query 148 to mobile device 114. In some embodiments, payment module 154 sends layaway account payoff amount 162 to pickup scheduling module 156 in response to pickup scheduling module 156 sending layaway pickup query 148 to mobile device 114, and mobile device 114 sending a pickup request 166 to layaway processing utility 122.

Mobile device 114 receives layaway pickup query 148 from layaway processing utility 122. Mobile computing device 114 will pass this information along to customer 112 via a display, speaker, or other input/output device. If customer 112 indicates to mobile computing device 114 that customer 112 wishes to pick up layaway item 152, mobile computing device 114 will send pickup request 166 to layaway processing utility 152, including one or both of payment module 154 and pickup scheduling module 156.

If customer 112 has paid off any balance due on layaway account 172 (layaway account payoff amount 162 is equal to zero) before entry into retail store 108, payment module 154 will send balance paid indicator 160 to pickup scheduling module 156. Pickup scheduling module 156 sends an activate drone request 190 to drone control module 158 in response to pickup scheduling module 156 receiving balance paid indicator 160. Drone control module 158 sends delivery request 150 to drone 140 in response to receiving activate drone request 190 from pickup scheduling module 156. Drone 140 opens drone garage 186 and delivers layaway item 152 to customer 112 in response to receiving delivery request 150.

In some embodiments, layaway item 152 is not stored in drone 140, and needs to be loaded by a person into drone 140. In this example embodiment, pickup scheduling module 156 sends a load drone request 168 to drone control module 158 and a stockroom input/output (I/O) device 176 (FIG. 2) in response to pickup scheduling module 156 receiving pickup request 166 from mobile device 114, and pickup scheduling module 156 receiving balance paid indicator 160 from payment module 154.

If customer 112 has a balance due on layaway account 172 when they enter retail store 108, payment module 154 sends payoff amount 162 to pickup scheduling module 156 in response to receiving payoff amount request 164 from pickup scheduling module 156. In some embodiments, pickup scheduling module 156 sends layaway account payoff amount 162 to mobile device 114 in response to pickup scheduling module 156 receiving pickup request 166 from mobile device 114. In some embodiments, pickup scheduling module 156 sends payoff amount 162 to mobile device 114 with layaway pickup query 148. Customer 112 can use mobile computing device 114 or any other method to pay for payoff amount 162 of layaway account 172. Once layaway account 172 has no balance due, payment module 154 will send balance paid indicator 160 to pickup scheduling module 156. If layaway item 152 is stored in drone 140, pickup scheduling module 156 sends activate drone request 190 to drone control module 158.

If layaway item 152 is not stored in drone 140, pickup scheduling module 156 sends load drone request 168 to both drone control module 158 and stockroom input/output (I/O) device 176 in response to pickup scheduling module 158 receiving pickup request 166 from mobile device 114, and pickup scheduling module 158 receiving balance paid indicator 160 from payment module 154. In some embodiments, pickup scheduling module 156 sends load drone request 168 to drone control module 158 in response to pickup scheduling module 158 receiving balance paid indicator 160 from payment module 154. In some embodiments, pickup scheduling module 156 sends load drone request 168 to stockroom I/O device 176 in response to pickup scheduling module 158 receiving balance paid indicator 160 from payment module 154.

Stockroom I/O device 176 is a device used for communication between layaway processing utility 122 and stockroom employees of retail store 108. In this embodiment, stockroom I/O device 176 is used to tell a stockroom employee that they should load layaway item 152 into drone 140 for those times when layaway item 152 has not been store or pre-loaded into drone 140, or is not automatically or robotically loaded. Stockroom I/O device 176 is also used for the stockroom employee to indicate to layaway processing utility 122 that drone 140 has been loaded with layaway item 152. Stockroom I/O device 176 can be a computer with a monitor and a keyboard located in the stockroom, for example. Stockroom I/O device can display load drone request 168 on a monitor for stockroom employees to see. Load drone request 168 includes instructions to load layaway item 152 into drone 140. The stockroom employees respond by loading layaway item152 into drone 140, and using a keyboard of stockroom I/O device 176 (for example), send a drone loaded indicator 174 to layaway processing utility 122. Drone loaded indicator 174 can include many types of information, including but not limited to, that layaway item 152 was loaded into drone 140, which compartment of drone 140 layaway item 152 was loaded into, and a passcode for customer 112 to use to open the compartment. Stockroom I/O device can be used to keep stockroom employees apprised of the status of layaway accounts so that employees can keep layaway merchandise that is likely to be picked up stored in a more convenient location so it does not take much time to retrieve it and put it into drone 140.

Stockroom I/O device 176 can be many different types of devices. In some embodiments, stockroom I/O device 176 is a mobile device carried by an employee of retail store 108. In some embodiments, stockroom I/O device 176 is some other I/O device used to tell one or more employees of retails store 108 to load layaway item 152 into drone 140, and to send drone loaded indicator 174 to layaway processing utility 122. Stockroom I/O device 176 is a means to inform one or more employees of retail store 108 that layaway item 152 is to be loaded into drone 140. And stockroom I/O device 176 is a means for one or more employee of retail store 108 to inform layaway processing utility 122 that layaway item 152 has been loaded into drone 140. In some embodiments, stockroom I/O device 176 is a means for one or more employee of retail store 108 to inform layaway processing utility 122 which compartment of drone 140 that layaway item 152 is loaded into. In some embodiments, stockroom I/O device 176 is a means for one or more employee of retail store 108 to inform layaway processing utility 122 a passcode, or security code, to open the compartment containing layaway item 152. In some embodiments, stockroom I/O device 176 is a means for one or more employee of retail store 108 to conduct other communications with layaway processing utility 122. In embodiment where layaway item 152 is not stored or pre-loaded into drone 140, once drone control module 158 receives drone loaded indicator 174 from stockroom I/O device 176, drone control module 158 sends delivery request 150 to drone 140.

Delivery request 150 instructs drone 140 to deliver layaway item 152 to customer 112. In the embodiment shown in the figures, drone 140 finds customer 112 in retail store 108, and delivers layaway item 152 to customer 112, as shown in FIG. 3, in response to receiving delivery request 150. In this embodiment, drone 140 finds customer 112 in retail store 108 by communicating with mobile computing device 114. In this embodiment, layaway processing utility 122 informs customer 112 that their layaway item 152 is in compartment 180. In some embodiments, layaway processing utility 122 will provide customer 112 with a password or code to open compartment 180. In some embodiments, customer 112 will open compartment 180 with an RFID tag, NFC tag, or with mobile device 114, as discussed above. Communication 134 between drone 140 and mobile computing device 114 can take many forms to allow customer 112 to open compartment 180 and remove layaway item 152, while keeping compartments 182 and 184 locked until opened by the customer associated with the layaway merchandise in those compartments. In some embodiments, communication 134 between drone 140 and mobile computing device 114 includes payments made towards the layaway account by customer 112. Drone 140 can be programmed to allow customer 112 to open compartment 180 once drone 140 receives the layaway account balance payment from mobile computing device 114.

In some embodiments, drone 140 will deliver layaway item 152 at the home of customer 112. In some embodiments, drone 140 is not stored at retail store 108. Drone garage 186 and drone 140 in drone garage 186 can be remote from retail store 108. Drone 140 can be stored in drone garage 186 in a storage facility, a garage facility, or any other facility for storing drone 140.

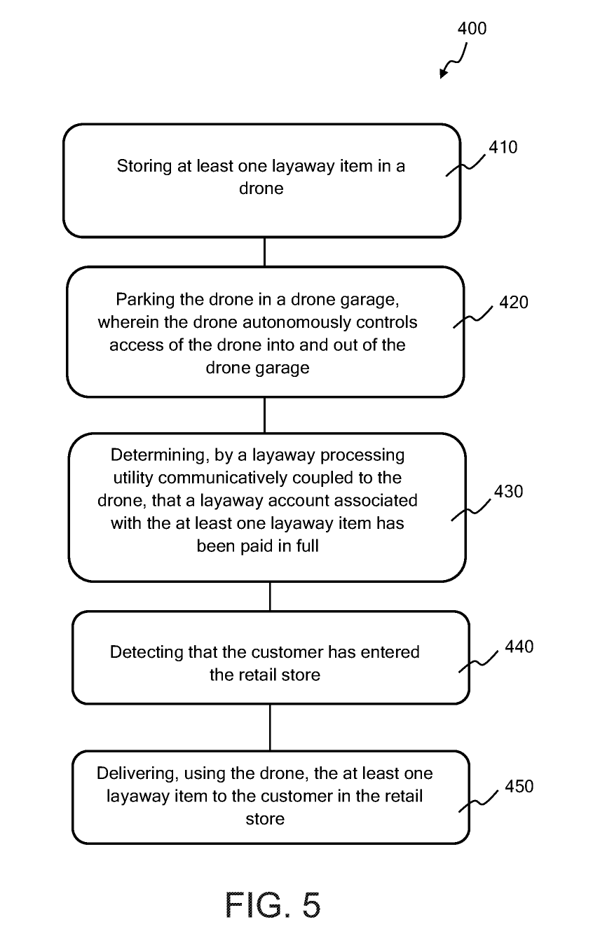

FIG. 5 illustrates a method 400 of storing and delivering at least one layaway item to a customer of a retail store. Method 400 includes an act 410 of storing the at least one layaway item in a drone. The layaway item is store in the drone so that the drone can autonomously deliver the layaway item once the layaway account is paid off. When the layaway item is stored in the drone, no employees are needed to load the drone when the layaway account is paid off, and the customer can get delivery of their layaway item quickly and easily.

Method 400 includes an act 420 of parking the drone in a drone garage, wherein the drone autonomously controls access of the drone into and out of the drone garage. The drone garage is a storage facility for the drone. The drone garage can be inside the retail store or outside the retail store, or separate from the retail store. The drone communicates with the drone garage to open and close doors, for example, and for any other types of communication that may occur between drone and drone garage.

Method 400 includes an act 430 of determining, by a layaway processing utility communicatively coupled to the drone, that a layaway account associated with the at least one layaway item has been paid in full. Once the layaway processing utility determines that a layaway account balance is paid off, the layaway processing utility can take steps to have the layaway item delivered to the customer.

Method 400 includes an act 440 of detecting that the customer has entered the retail store. A detector is used to detect when a customer enters the store. If the customer is on the store and the layaway account is paid off, the layaway item can be delivered to the customer in the store. In some embodiments, method 400 includes sending a customer detection indicator from the detector to the layaway processing utility of the retail store, in response to the detector detecting that the customer has entered the retail store

Method 400 includes an act 450 of delivering, using the drone, the at least one layaway item to the customer in the retail store. The drone can find the customer in the store. Or, the drone can meet the customer at a pre-arranged location in the store. In some embodiments, the drone delivers the layaway item to the customer at their home.

In some embodiments, the layaway processing utility communicates with a mobile computing device carried by the customer. In some embodiments, method 400 includes sending a layaway pickup query from a pickup scheduling module of the layaway processing utility to the mobile computing device carried by the customer. In some embodiments, method 400 includes sending a layaway payoff balance from a payment module of the layaway processing utility to the mobile computing device. In some embodiments, method 400 includes receiving a layaway payment from the mobile computing device. In some embodiments, method 400 includes determining, by a payment module of the layaway processing utility that the layaway account payoff amount has been paid in full. In some embodiments, method 400 includes sending a balance paid indicator associated with the at least one layaway item from the payment module to a pickup scheduling module of the layaway processing utility.

In some embodiments, method 400 includes sending a delivery request from a drone control module of the layaway processing utility to the drone in response to the drone control module receiving an activate drone request from the pickup scheduling module.

There may be cases where employee help is needed to add layaway items to the account or exchange items. In some embodiments, the layaway item may not of been loaded into the drone. In some embodiments, method 400 includes sending a load drone request from a pickup scheduling module of the layaway processing utility to a stockroom input/output device.

A layaway system for a retail store has been shown and described that is a system for organizing layaway pickups. The layaway system includes a detector that detects when a customer enters the retail store. The detector can use the mobile computing device of the customer to detect when the customer enters the retails tore, or any other customer detection method. The detector communicates with a layaway processing utility that can be resident on a store server of the retail store. The layaway processing utility works with the detector to determine the identity of the customer. If the customer has a layaway account at the retail store, the layaway processing utility communicates with the customer, using any number of methods including a store kiosk or the mobile computing device of the customer, to determine if the customer is going to pick up their layaway merchandise. The layaway processing utility can communicate with the customer to pre-schedule the layaway pickup and to accept payments to pay off the balance of the layaway account. Once the layaway processing utility knows that the layaway account is paid off and that the customer wishes to pick up their layaway merchandise, the layaway processing utility has the layaway merchandise delivered using a drone. The drone finds the customer in the retail store, and delivers the layaway merchandise to the customer. This layaway system reduces wait time for a customer who is picking up their layaway merchandise, and reduces employee time needed to deliver the layaway merchandise to the customer. The drone can also be used to deliver the layaway item to the customer's home. The layaway item can be stored in the drone to eliminate having to load the drone once the layaway account is paid off. The drone can be stored in a drone garage that the drone controls, so the drone can enter and exit the drone garage autonomously.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A layaway system for a retail store comprising:
a layaway processing utility, wherein the layaway processing utility stores a layaway account associated with at least one layaway item, and wherein the layaway account is opened by a customer of the retail store;
a detector communicatively coupled to the layaway processing utility, wherein the detector sends a customer detection indicator to the layaway processing utility in response to the detector detecting that the customer has entered the retail store; and
a drone communicatively coupled to the layaway processing utility, wherein the drone delivers the at least one layaway item to the customer in response to receiving a delivery request from the layaway processing utility.

2. The layaway system of claim 1, further comprising a display located in the retail store, wherein a rendering of a person is shown on the display to inform the customer of the status of the layaway account of the customer.

3. The layaway system of claim 1, further comprising a drone garage communicatively coupled to the drone, wherein the at least one layaway item is loaded into the drone when the customer opens the layaway account, and wherein the at least one layaway item and the drone are stored in the drone garage until the layaway account is paid off.

4. The layaway system of claim 3, wherein the layaway processing utility finds the layaway account belonging to the customer in response to receiving the customer detection indicator from the detector.

5. The layaway system of claim 4, wherein the layaway processing utility sends a layaway pickup query to a mobile computing device of the customer in response to the detector detecting that the customer has entered the retail store and the layaway processing utility finding the layaway account belonging to the customer.

6. The layaway system of claim 5, wherein the layaway processing utility comprises a payment module, a pickup scheduling module, and a drone control module.

7. The layaway system of claim 6, wherein the payment module sends a layaway account payoff amount to the pickup scheduling module in response to the mobile computing device sending a pickup request to the layaway processing utility.

8. The layaway system of claim 7, wherein the pickup scheduling module sends the layaway account payoff amount to the mobile computing device in response to the pickup scheduling module receiving the layaway account payoff amount from the payment module.

9. The layaway system of claim 7, wherein the payment module sends a balance paid indicator to the pickup scheduling module in response to the layaway account payoff amount being equal to zero.

10. The layaway system of claim 9, wherein the pickup scheduling module sends a load drone request to a stockroom input/output device in response to the pickup scheduling module receiving the balance paid indicator.

11. The layaway system of claim 10, wherein the drone control module instructs the drone to deliver the at least one layaway item in response to the drone control module receiving a drone loaded indicator from the stockroom input/output device.

12. The layaway system of claim 9, wherein the pickup scheduling module sends an activate drone request to the drone control module in response to the pickup scheduling module receiving the balance paid indicator.

13. The layaway system of claim 12, wherein the drone control module sends the delivery request to the drone in response to receiving the activate drone request from the pickup scheduling module.

14. The layaway system of claim 13, wherein the drone opens the drone garage and delivers the at least one layaway item in response to receiving the delivery request.

15. A method of storing and delivering at least one layaway item to a customer of a retail store, the method comprising:
storing the at least one layaway item in a drone;
parking the drone in a drone garage, wherein the drone autonomously controls access of the drone into and out of the drone garage;
determining, by a layaway processing utility communicatively coupled to the drone, that a layaway account associated with the at least one layaway item has been paid in full;
detecting that the customer has entered the retail store; and
delivering, using the drone, the at least one layaway item to the customer in the retail store.

16. The method of claim 15, further comprising sending a customer detection indicator from a detector to the layaway processing utility of the retail store, in response to the detector detecting that the customer has entered the retail store.

17. The method of claim 16, further comprising:
sending a layaway pickup query from a pickup scheduling module of the layaway processing utility to a mobile computing device carried by the customer; and
sending a layaway account payoff amount from a payment module of the layaway processing utility to the mobile computing device.

18. The method of claim 17, further comprising sending a load drone request from the pickup scheduling module to a stockroom input/output device.

19. The method of claim 17, further comprising:
determining, by a payment module of the layaway processing utility, that the layaway account payoff amount has been paid in full; and
sending a balance paid indicator associated with the at least one layaway item from the payment module to a pickup scheduling module of the layaway processing utility.

20. The method of claim 15, further comprising sending a delivery request from a drone control module of the layaway processing utility to the drone in response to the drone control module receiving an activate drone request from the pickup scheduling module.
